(19) United States
(12) Patent Application Publication
(10) Pub. No.: US 2022/0179205 A1
(43) Pub. Date: Jun. 9, 2022

(54) SYSTEM AND METHOD OF USE INCLUDING PATTERNED BALLS FOR TRAINING

(71) Applicant: Camden Taylor Marcotte, Dartmouth, MA (US)

(72) Inventor: Camden Taylor Marcotte, Dartmouth, MA (US)

(21) Appl. No.: 17/546,313

(22) Filed: Dec. 9, 2021

Related U.S. Application Data
(60) Provisional application No. 63/123,146, filed on Dec. 9, 2020.

(51) Int. Cl. G02B 27/00; G06F 3/048; G06F 17/00; G02B 27/01; G06F 3/01; A61H 5/00

(52) U.S. Cl. CPC G02B 27/0093; G06F 3/048; G06F 17/00; G02B 2027/0112; G06F 3/013; A61H 5/00; G02B 27/01

(57) ABSTRACT

A system of patterned balls configured for use in therapies, the system including a computing device configured to receive a user input associated with a first user condition, correlate the first user condition to a first pattern, select a first ball that includes the first pattern correlated to the first user condition, and present the first ball to the user. A first ball, including a first pattern comprising the first color and the second color disposed on the first ball, a first axis of rotation, a second ball, including a second pattern comprising the third color and the fourth color disposed on the second ball, a second axis of rotation, a suspension assembly configured to suspend the first ball and the second ball in orientations, and a rotation apparatus configured to rotate at least the first and second ball. A method for therapies is also disclosed.

### CROSS-REFERENCE TO RELATED APPLICATIONS

This application claims the benefit of priority of U.S. Provisional Patent Application Ser. No. 63/123,146, filed on Dec. 9, 2020, and titled “SYSTEM OF PATTERNED BALLS CONFIGURED FOR USE IN THERAPIES,” which is incorporated by reference herein in its entirety.

### FIELD OF THE INVENTION

The present invention generally relates to the field of therapy. In particular, the present invention is directed to a system of patterned balls configured for use in therapies.

### BACKGROUND

Catching a ball involves a combination of ocular movements and head movements to track the object. Following a concussion or other injuries/disorders that may involve the central vestibular/ocular components of the brain, eye movements such as smooth pursuits, optokinetic response, vestibular ocular reflex, convergence, saccades, among others may be impacted. The goal of such therapy is to help provoke an optokinetic response (combined saccade and smooth pursuit rotation) with the patient, which can help challenge the patient's oculomotor control, balance, and mental processing depending on the task that is performed and help assist with sensory integration type tasks for patients post-concussion or patients with symptoms of visual vertigo. Through the use of low tech and low-cost equipment and the application of functional exercises, the hope is to help facilitate habituation exercises and accelerate rehab gains in the clinic at a reasonable price.

### SUMMARY OF THE DISCLOSURE

In an aspect, a system of patterned balls configured for use in therapies includes a computing device, the computing device is configured to receive a user input from a user associated with a first user condition, correlate the first user condition to a first pattern, select a first ball that includes the first pattern correlated to the first user condition, and present the first ball to the user. The system of patterned balls configured for use in therapies includes a first ball, wherein the first ball includes a first color disposed on a portion of the surface of the first ball and a second color disposed on a portion of the surface of the first ball, a first pattern comprising the first color and the second color disposed on the first ball associated with a first therapy, a first axis of rotation about which the first ball may rotate. The system of patterned balls configured for use in therapies includes a second ball, wherein the second ball comprises, a third color disposed on a portion of the surface of the first ball and a fourth color disposed on a portion of the surface of the second ball, a second pattern comprising the third color and the fourth color disposed on the second ball associated with a second therapy, and a second axis of rotation about which the second ball may rotate. The system of patterned balls configured for use in therapies includes a suspension assembly, wherein the suspension assembly includes a first suspension apparatus configured to suspend the first ball in a first orientation associated with the first therapy, a second suspension apparatus configured to suspend the second ball in a second orientation associated with the second therapy, and a rotation apparatus configured to rotate at least the first ball about the first axis of rotation and the second ball about the second axis of rotation.

In another aspect, an exemplary method of training includes performing, using an optokinetic ball, oculomotor training as a function of at least a training parameter, wherein performing the oculomotor training includes propelling the optokinetic ball to a participant according to at least a propulsion parameter, and varying the at least a propulsion parameter, wherein the optokinetic ball includes a first color covering about half of a surface area of the optokinetic ball, a second covering about half of the surface area of the optokinetic ball, wherein a contrast ratio between the first color and the second color is no less than a minimum contrast threshold, and wherein, the first color and the second color are arranged on the surface area of the optokinetic ball in a pattern configured to produce an optokinetic stimulus when the optokinetic ball is rotated.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an embodiment of a system of colored balls configured for therapy use;

FIG. 2A-G are illustrations of examples of colored balls in orthogonal views;

FIG. 3 is an illustration of two embodiments of a system of colored balls configured for therapy use and suspension assemblies thereof;

FIG. 4 is a block diagram of an exemplary machine learning process;

FIG. 5 is a flow diagram illustrating an exemplary method of oculomotor training according to some embodiments; and

FIG. 6 is a block diagram illustrating an exemplary embodiment of a computer system.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

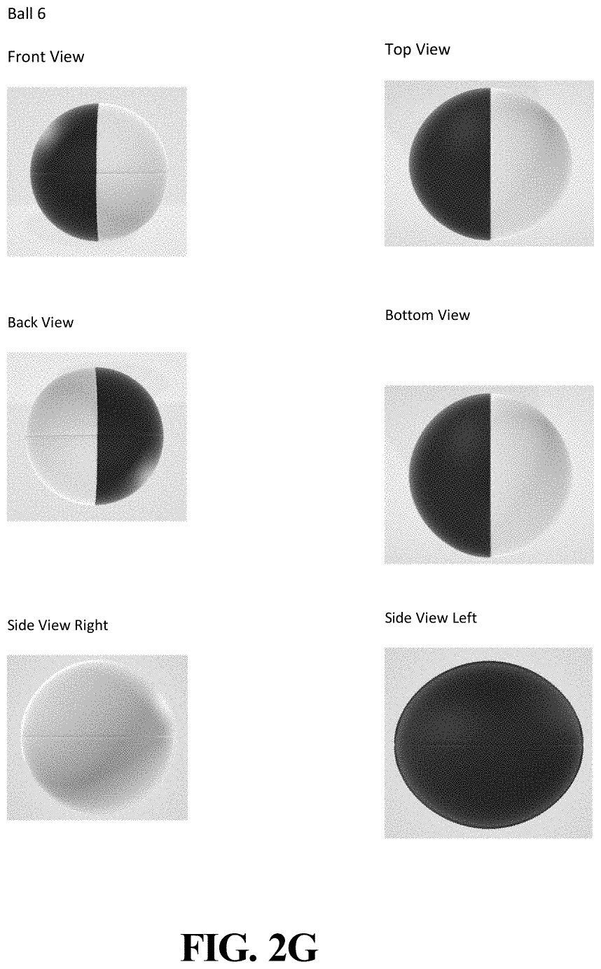

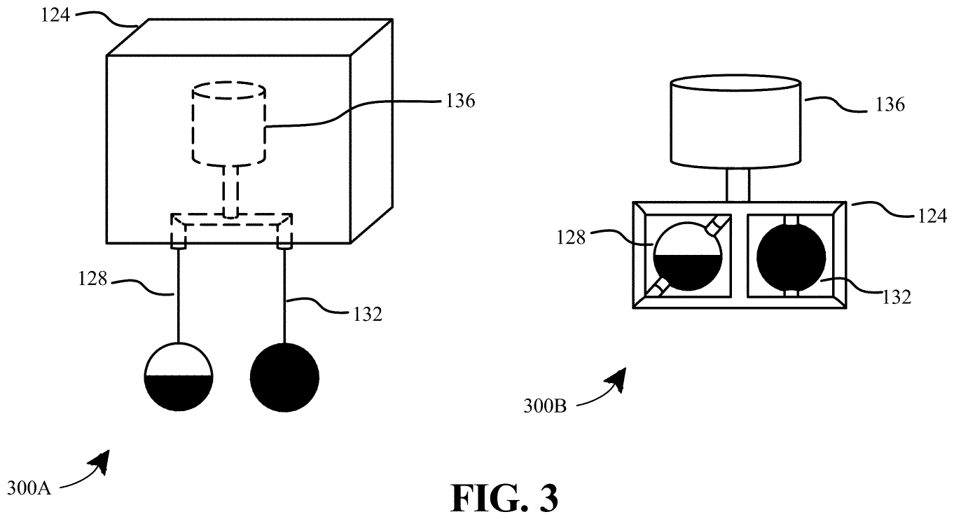

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to orientation as illustrated for exemplary purposes in FIG. 3. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply embodiments of the inventive concepts defined in the appended claims. Hence, specific dimensions and other physical characteristics relating to the embodiments disclosed herein are not to be considered as limiting, unless the claims expressly state otherwise.

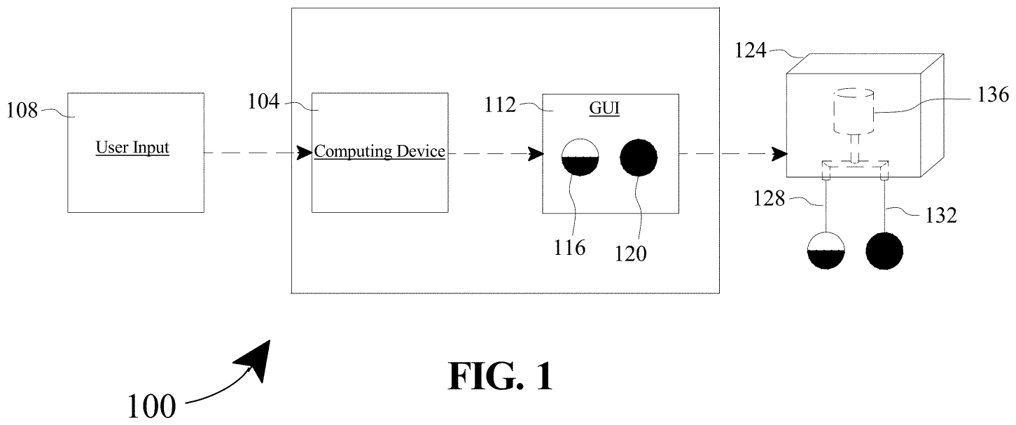

Referring now to FIG. 1, a system of patterned balls configured for use in therapies is presented. System 100 includes computing device 104. Computing device 104 may include a processor, system on a chip, and/or a combination of circuits. Computing device 104 may be consistent with computing systems disclosed in this paper. Computing device 104 may include any computing device as described in this disclosure, including without limitation a microcontroller, microprocessor, digital signal processor (DSP) and/or system on a chip (SoC) as described in this disclosure. Computing device 104 may include, be included in, and/or communicate with a mobile device such as a mobile telephone or smartphone. Computing device 104 may include a single computing device operating independently, or may include two or more computing device operating in concert, in parallel, sequentially or the like; two or more computing devices may be included together in a single computing device or in two or more computing devices. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from a computer and/or a computing device. Computing device 104 may include but is not limited to, for example, a computing device or cluster of computing devices in a first location and a second computing device or cluster of computing devices in a second location. Computing device 104 may include one or more computing devices dedicated to data storage, security, distribution of traffic for load balancing, and the like. Computing device 104 may distribute one or more computing tasks as described below across a plurality of computing devices, which may operate in parallel, in series, redundantly, or in any other manner used for distribution of tasks or memory between computing devices. Computing device 104 may be implemented using a “shared nothing” architecture in which data is cached at the worker, in an embodiment, this may enable scalability of the system and/or computing device 104.

Computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Computing device 104 is configured to receive user input 108 associated with a first user condition. The first user condition may be a brain injury, concussion, or other condition that requires therapy. Computing device 104 is configured to correlate the first user condition to a first pattern. The first pattern may be effective in therapy for the correlated user condition to which computing device 104 has correlated and matched it to. Computing device 104 is configured to select a first ball that includes the first pattern correlated to the first user condition. Computing device 104 presents the first ball to the user, and in some embodiments may display the first ball in GUI 112.

With continued reference to FIG. 1, additionally, or alternatively, system 100 may include therapies which include exercises using first ball 116 and second ball 120 manually, any of which may include optokinetic rotations. Exercises may include, but not limited to “catch and toss while seated with back support”, “catch and toss while seated without back support”, “catch and toss while seated on unstable surface without back support”, “standing catch and toss”, “catch and toss while standing on unstable surface (foam, BOSU, shuttle system, etc.)”, “parabola over the shoulder catch and toss”, “ladder drills catch and toss”, “forward step ups catch and toss”, “lateral step ups catch and toss”, “90 degree jump turns catch and toss”, “180 degree jump turns catch and toss”, “walking catch and toss”, “running catch and toss”, “soccer passes”, “dribbling”, “basketball shooting”, “baseball batting practice”, “volleyball serve, digs, and bumps”, and “volleyball pepper” and the like.

With continued reference to FIG. 1, system 100 may be completely or partially virtual. User input 108 may be received by computing device 104, which may include, without limitation, a smartphone, smartphone application, computer program, or the like. A selection of First ball 116 and second ball 120 may be presented to the user in GUI 112 which may also be disposed within smartphone application. Optokinetic response may be triggered by the rotation of first ball 116 and second ball 120, for instance, in a virtual environment where first ball 116 may be presented as a series of patterns on a screen. First ball 116 and/or second ball 120 may be rotated and presented on a screen to induce an optokinetic response. One of ordinary skill in the art, upon reviewing the entirety of this disclosure, would appreciate any non-limiting embodiment of the herein disclosed system may be used in an electronic or virtual platform. One of ordinary skill in the art, upon reviewing the entirety of this disclosure, would also appreciate that a smartphone or electronic device may require a specific program or application uploaded or downloaded onto it. Any portion of system 100, may be completely or partially virtual, and may include prerecorded video or animations of first ball 116 and/or second ball 120 with certain patterns and rotations consistent with this disclosure.

With continued reference to FIG. 1, any portion of system 100 may include augmented reality that may be implemented in any suitable way, including without limitation incorporation of or in a head mounted display, a head-up display, a display incorporated in eyeglasses, goggles, headsets, helmet display systems, or the like, a display incorporated in contact lenses, an eye tap display system including without limitation a laser eye tap device, VRD, or the like. A display may display first ball 116 and second ball 120 as holographic displays rotating with patterns, rotations, and orientations consistent with this disclosure. A display, for the purposes of this disclosure, is a device that permits a user to view a typical field of vision of the user and superimposes virtual images on the field of vision, namely a first and second rotating, patterned ball. A display may alternatively or additionally be implemented, for instance, using a projector, which may display images received from a therapist, prerecorded videos, animations, as described in further detail below, into an a display as described in further detail below. A person skilled in the art, upon reviewing the entirety of this disclosure, will be aware of various optical projection and/or display technologies that may be incorporated in a display consistently with this disclosure. A display may implement a stereoscopic display. A “stereoscopic display,” as used in this disclosure, is a display that simulates a user experience of viewing a three-dimensional space and/or object, for instance by simulating and/or replicating different perspectives of a user's two eyes; this is in contrast to a two-dimensional image, in which images presented to each eye are substantially identical, such as may occur when viewing a flat screen display. Stereoscopic display may display two flat images having different perspectives, each to only one eye, which may simulate the appearance of an object or space as seen from the perspective of that eye. Alternatively or additionally, stereoscopic display may include a three-dimensional display such as a holographic display or the like. Persons skilled in the art, upon reviewing the entirety of this disclosure, will be aware of various alternative or additional types of stereoscopic display that may be employed in a display.

With continued reference to FIG. 1, catching a ball involves a combination of oculomotor movements and head movements to track the object. Following a concussion or other injuries/disorders that may involve the central vestibular/ocular components of the brain, eye movements such as smooth pursuits, optokinetic response, vestibular ocular reflex, saccades, convergence among others may be impacted. “Saccades,” for the purposes of this disclosure, refer to rapid, conjugate eye rotations that quickly move the eyes to place the fovea on target of interest. “Fovea,” for the purpose of this disclosure, refers to a small depression in the retina of the eye, where visual acuity is the highest, the center of the field of vision is focused on this region where retinal cones are particularly concentrated. “Smooth pursuit,” for the purposes of this disclosure, refers to a system for stabilizing a moving target on the fovea of the retina during low velocities and frequencies of head motion or target motion. “Optokinetic response,” for the purposes of this disclosure refers to combined saccade and smooth pursuit eye rotation consistent with this the description herein. System 100 includes balls with patterns on the balls that help evoke the optokinetic response during smooth pursuits as a form of habituation exercise. Optokinetic technology tends to use advanced technology to help evoke an optokinetic response such as virtual reality systems and advanced rooms to simulate desired environments/stimuli. System 100 utilizes low tech colored pattern balls to help evoke an optokinetic response and help habituate patients with limitations to visual stimulating environments and stimuli. The spinning of first ball 116 or second ball 120 when tossed to a patient can help provoke an optokinetic response with the patient, which can help challenge the patient's oculomotor control, balance, and mental processing depending on the task that is performed.

With continued reference to FIG. 1, first ball 116 and second ball 120 are used either in isolation as a form of oculomotor training, proprioceptive awareness, and reaction time training, or in conjunction with other exercise to help assist with sensory integration type tasks for patients post-concussion or patients with symptoms of visual vertigo consistent with the description of system 100. System 100 may include therapies directed to post-concussion patients and other patients that exhibit symptoms of visual vertigo or have other visual deficits that affect optokinetic responses. Non-limiting examples of these therapies include, tests to monitor smooth pursuits, saccadic performance, or tests that may show various patterns moving in an optokinetic pattern to determine accuracy of eye movements, symptoms experienced, and overall performance to assigned tasks, or the like.

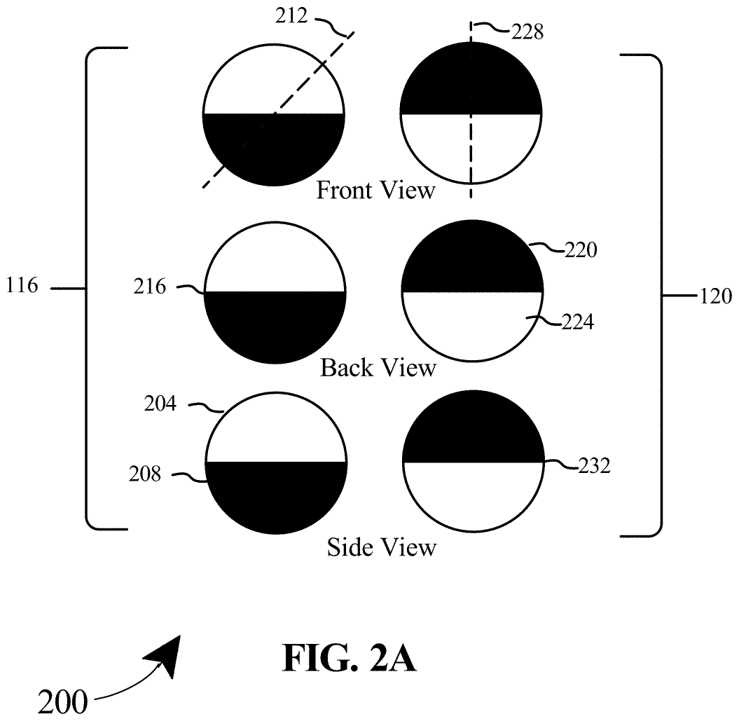

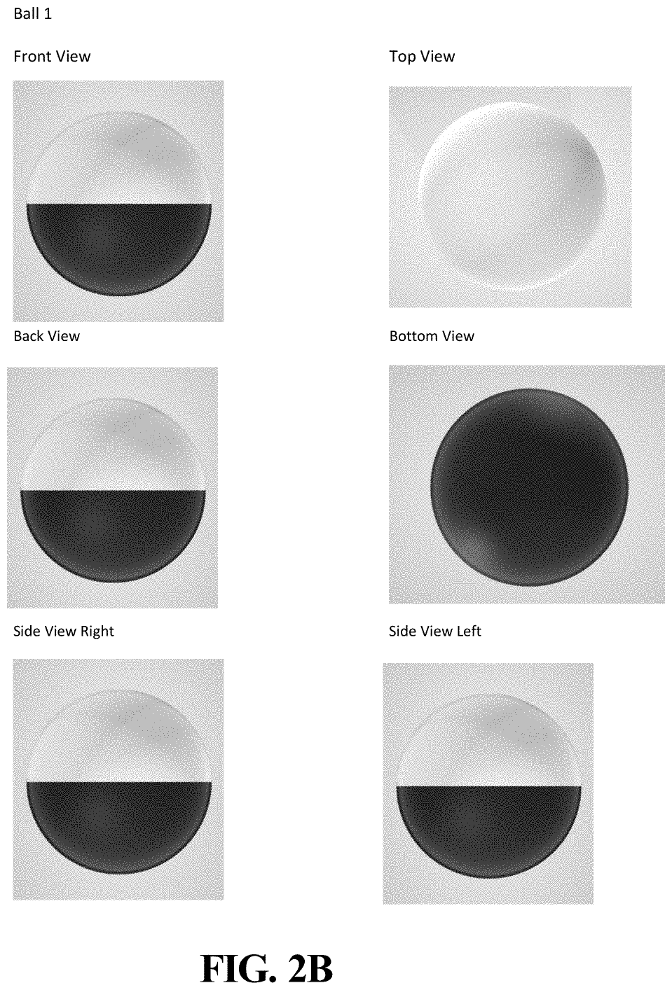

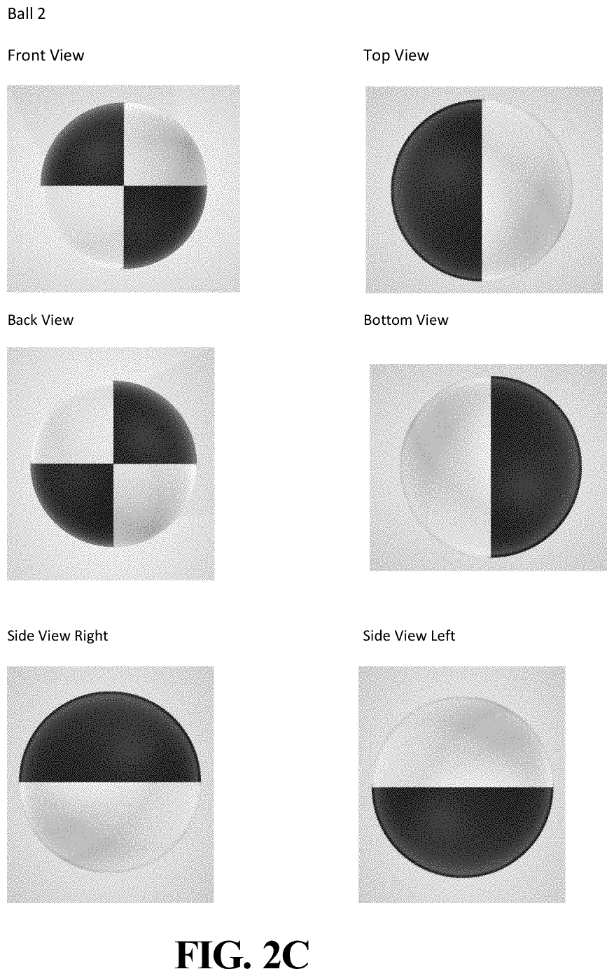

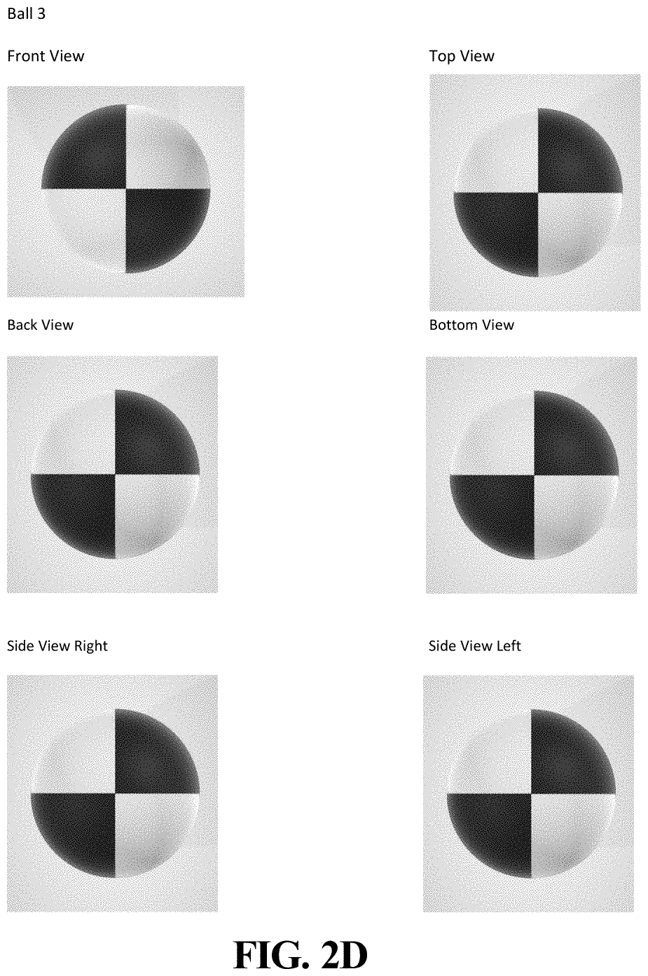

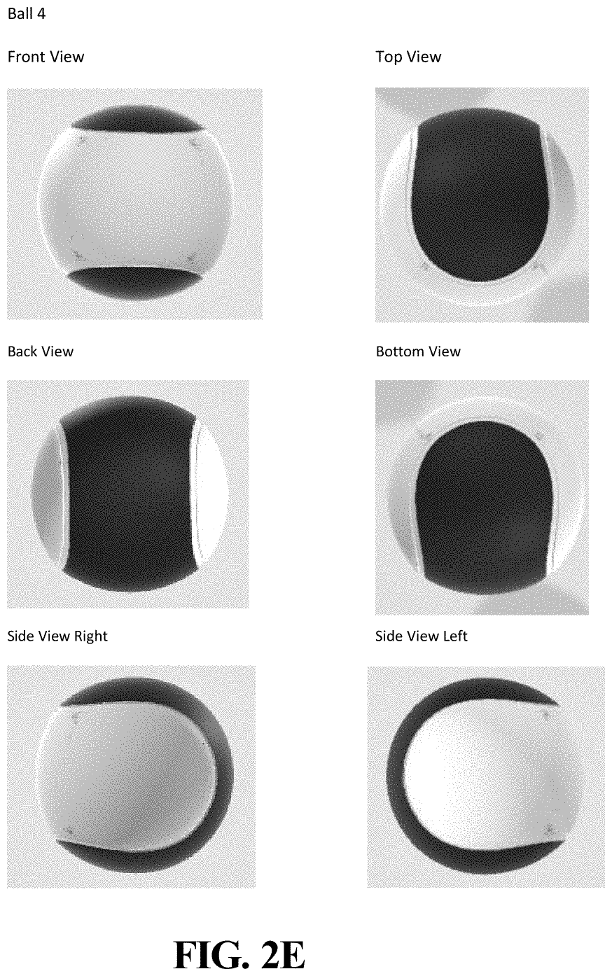

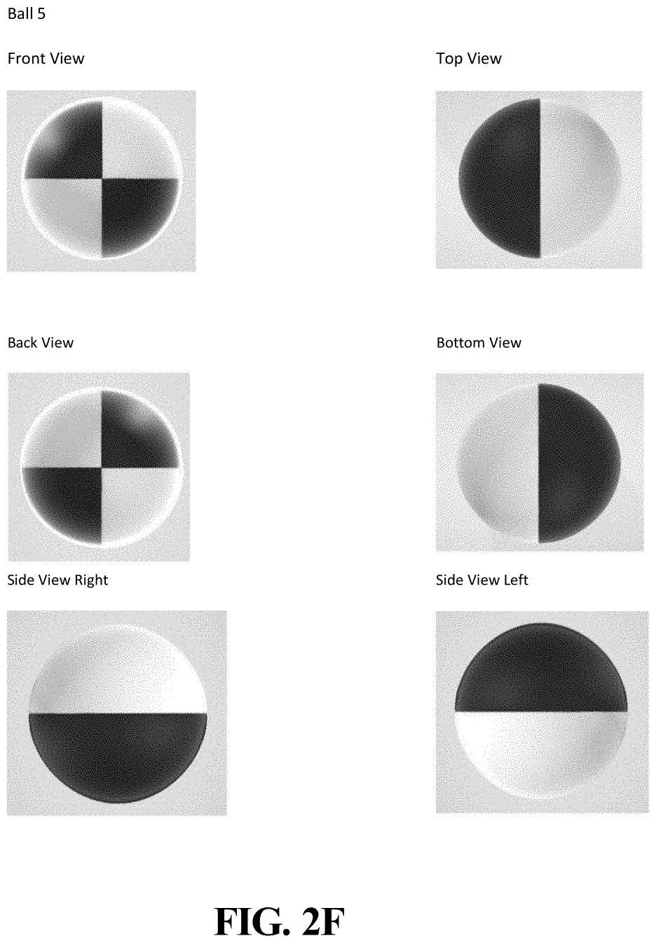

Referring now to FIG. 2A, system 200 includes the first ball 116. First ball 116 includes first color 204 disposed on the surface of first ball 116 and second color 208 disposed on the surface of first ball 116. First color 204 may be applied to at least a portion of first ball 116. First color 204 may be painted, electrostatically plated, sprayed on, or the like. First color 204 may be the constituent color of the material of at least a portion of first ball 116. For example, first color 204 may be a blue thermoplastic used to injection-mold the ball. First color 204 may include a texture corresponding to the color. For example, a dimpled texture may correspond to first color 204. First ball 116 includes second color 208 that may include any and all of the same features as first color 204. The combination of first color 204 and second color 208 produces first pattern 216. First pattern 216 is associated with a first therapy.

With continued reference to FIG. 2A, first ball 116 includes first axis of rotation 212 about which first ball 116 rotates. First axis of rotation 212 may intersect the center of the first ball 116, it may also include an axis intersecting any portion of first ball 116. First ball 116 may be constructed of a thermoplastic, such as, but not limited to Nylon, Delrin-Acetal, Teflon, Polycarbonate, Acrylic, Polypropylene, and the like. First ball 116 may be additively manufactured using, for example a 3D printer.

With continued reference to FIG. 2A, system 100 may include a second ball 120. Second ball 120 includes third color 220 disposed on a portion of the surface of second ball 120 and fourth color 224 disposed on the surface of second ball 120. Third color 220 and fourth color 224, together, produces second pattern 232. Second pattern 232 is associated with a second therapy. Second therapy may be associated with a user condition. Second ball 120 includes second axis of rotation 228 about which second ball 120 may rotate. Second axis of rotation 228 may intersect with the center of second ball 120. Second axis of rotation may intersect with at least a portion of second ball 120 and/or be located remotely from the physical second ball 120. One of ordinary skill in the art, upon reviewing the entirety of this disclosure, would appreciate that the embodiments shown here are only non-limiting examples, and not preclude other dispositions of color and pattern of first ball 116 and second ball 120. There may be repeating colors, more than two colors, more than two textures, or any number and combination of any of the foregoing. Any of the balls described herein do not necessarily have to be sphere or ball-shaped and may include oblong or other prismatic shapes. FIGS. 2B-G are alternative or additional embodiments of balls that may be used in the herein disclosed system.

Referring now to FIG. 3, system 300A includes suspension assembly 124. Suspension assembly includes first suspension apparatus 128 configured to suspend first ball 116 in a first orientation associated with the first therapy. “Orientation,” for the purposes of this disclosure, refers to the first or second ball's position relative to the first suspension apparatus 128. First suspension apparatus 128 is mechanically coupled to rotation apparatus 136 at a first end and first ball 116 at first axis of rotation 212 at a second end. It should also be noted that other mechanical coupling mechanisms may be used that are not necessarily designed for quick removal. The mechanical coupling may include, as a non-limiting example, rigid coupling (e.g. beam coupling), bellows coupling, bushed pin coupling, constant velocity, split-muff coupling, diaphragm coupling, disc coupling, donut coupling, elastic coupling, flexible coupling, fluid coupling, gear coupling, grid coupling, Hirth joints, hydrodynamic coupling, jaw coupling, magnetic coupling, Oldham coupling, sleeve coupling, tapered shaft lock, twin spring coupling, rag joint coupling, universal joints, or any combination thereof. In other words, the point on the surface of first ball 116 to which first suspension apparatus is mechanically coupled to, also intersects with first axis of rotation 212. First suspension apparatus 128 may include a first wire with a first length associated with a first therapy. First suspension apparatus 128 may be configurable to include a plurality of lengths associated with any of a plurality of therapies.

With continued reference to FIG. 3, suspension assembly 300B may include a framework in which first ball 116 and second ball 120 are disposed within. Suspension assembly 300B includes any of the same components as 300A consistent with this disclosure. First ball 116 and second ball 120 may be disposed within recesses within framework included in suspension assembly 300B. First ball 116 is disposed in suspension assembly 300B with at least a portion of the ball's surface exposed and configured to be visible to the user.

Referring again to FIG. 3, suspension assembly 124 is configured to suspend the second ball 120 in a second orientation associated with the second therapy through second suspension apparatus 132. Second suspension apparatus 132 includes may include a second wire with a second length associated with a second therapy. Second suspension apparatus 132 may be configurable to have a plurality of lengths associated with any of a plurality of therapies.

Referring again to FIG. 1, rotation apparatus 136 is configurable to rotate the first ball 116 a first amount of time. The first amount of time may be associated with a first therapy, a first pattern, first or second colors, or inputted by the user or a technician. Rotation apparatus 136 is configurable to rotate at least the second ball 120 a second amount of time. The second amount of time may be associated with a second therapy, a second pattern, a third or fourth color, or inputted by the user of the technician. Rotation apparatus 136 may be configured to utilize electrical energy. Rotation apparatus 136 may be configured to utilize electrochemical energy. Rotation apparatus 136 may be configured to utilize solar energy. Rotation apparatus 136 may include an electric motor, a spring, a gas-powered engine, an elastically driven mechanism, a clock mechanism, a human appendage (like throwing, headbutting, kicking, or striking one or both balls) or another like machine that converts types of energy into kinetic energy, causing motion, namely of the first ball 116 and second ball 120.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

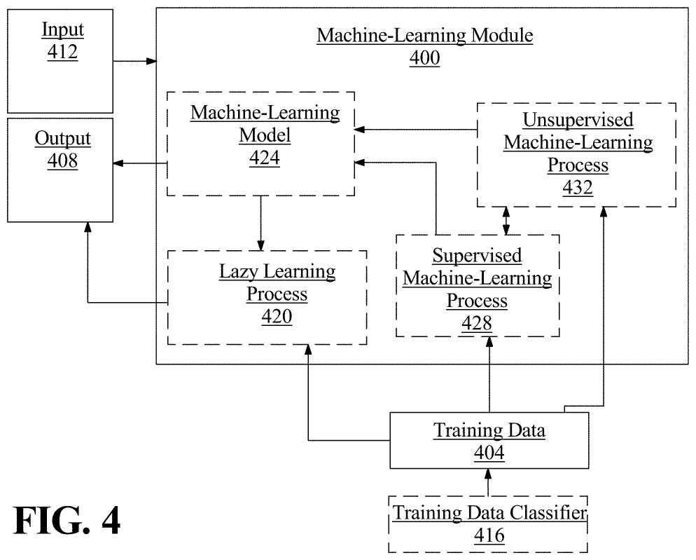

Referring now to FIG. 4, an exemplary embodiment of a machine-learning module 400 that may perform one or more machine-learning processes as described in this disclosure is illustrated. Machine-learning module may perform determinations, classification, and/or analysis steps, methods, processes, or the like as described in this disclosure using machine learning processes. For instance, a machine-learning process may be implemented to detect the center of pupils in Optokinetic Nystagmus detection methods. In another example, a classification algorithm may be implemented that uses, for example, a therapist score of a patient's progress which would then output a progression of an exercise that may be used by a patient. A “machine learning process,” as used in this disclosure, is a process that automatedly uses training data 404 to generate an algorithm that will be performed by a computing device/module to produce outputs 408 given data provided as inputs 412; this is in contrast to a non-machine learning software program where the commands to be executed are determined in advance by a user and written in a programming language.

Still referring to FIG. 4, “training data,” as used herein, is data containing correlations that a machine-learning process may use to model relationships between two or more categories of data elements. For instance, and without limitation, training data 404 may include a plurality of data entries, each entry representing a set of data elements that were recorded, received, and/or generated together; data elements may be correlated by shared existence in a given data entry, by proximity in a given data entry, or the like. Multiple data entries in training data 404 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 404 according to various correlations; correlations may indicate causative and/or predictive links between categories of data elements, which may be modeled as relationships such as mathematical relationships by machine-learning processes as described in further detail below. Training data 404 may be formatted and/or organized by categories of data elements, for instance by associating data elements with one or more descriptors corresponding to categories of data elements. As a non-limiting example, training data 404 may include data entered in standardized forms by persons or processes, such that entry of a given data element in a given field in a form may be mapped to one or more descriptors of categories. Elements in training data 404 may be linked to descriptors of categories by tags, tokens, or other data elements; for instance, and without limitation, training data 404 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 4, training data 404 may include one or more elements that are not categorized; that is, training data 404 may not be formatted or contain descriptors for some elements of data. Machine-learning algorithms and/or other processes may sort training data 404 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 404 to be made applicable for two or more distinct machine-learning algorithms as described in further detail below. Training data 404 used by machine-learning module 400 may correlate any input data as described in this disclosure to any output data as described in this disclosure.

Further referring to FIG. 4, training data may be filtered, sorted, and/or selected using one or more supervised and/or unsupervised machine-learning processes and/or models as described in further detail below; such models may include without limitation a training data classifier 416. Training data classifier 416 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 400 may generate a classifier using a classification algorithm, defined as a processes whereby a computing device and/or any module and/or component operating thereon derives a classifier from training data 404. Classification may be performed using, without limitation, linear classifiers such as without limitation logistic regression and/or I Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 416 may classify elements of training data to different participant cohorts, different oculomotor-related disorders and the like. In some cases, training data classifier 416 may classify training data according to different abilities of a participant. For instance, in some cases, a participant may be able to perform certain tasks and not others. In some cases, classification of training parameters may thus be done as a method of accommodating different participants or different classes or cohorts of participants. In another example, classification of training parameters may be a method of selecting a set of exercises depending on the condition.

Still referring to FIG. 4, machine-learning module 400 may be configured to perform a lazy-learning process 420 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 404. Heuristic may include selecting some number of highest-ranking associations and/or training data 404 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 4, machine-learning processes as described in this disclosure may be used to generate machine-learning models 424. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 424 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 424 may be generated by creating an artificial neural network, such as a convolutional neural network comprising an input layer of nodes, one or more intermediate layers, and an output layer of nodes. Connections between nodes may be created via the process of “training” the network, in which elements from a training data 404 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 4, machine-learning algorithms may include at least a supervised machine-learning process 428. At least a supervised machine-learning process 428, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include oculomotor measures as described throughout as inputs, propulsion parameters and/or training parameters as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 404. Persons skilled in the art, upon reviewing the entirety of this disclosure, will be aware of various possible variations of at least a supervised machine-learning process 428 that may be used to determine relation between inputs and outputs. Supervised machine-learning processes may include classification algorithms as defined above.

Further referring to FIG. 4, machine learning processes may include at least an unsupervised machine-learning processes 432. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 4, machine-learning module 400 may be designed and configured to create a machine-learning model 424 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 4, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

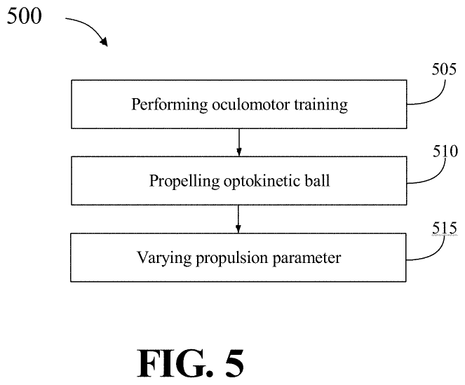

Referring now to FIG. 5, an exemplary method 500 of training is illustrated by way of a flow diagram. At step 505, method 500 may include performing an oculomotor training. As used in this disclosure, “oculomotor training” is an activity which purposefully results in movement of a participant's eye. In some cases, oculomotor training may be performed using an optokinetic ball.

With continued reference to FIG. 5, as used in this disclosure an “optokinetic ball” is any ball configured to produce an optokinetic stimulus when rotated. Optokinetic ball may be of any type or shape, including round, oblate, oblong, and the like. An optokinetic ball may include any ball described in this disclosure, including with reference to FIGS. 1-4. In some cases, optokinetic ball may include a first color covering about half of a surface area of the optokinetic ball and a second color covering about half of the surface area of the optokinetic ball. In some cases, a contrast ratio between first color and second color may be no less than a minimum contrast threshold. As used in this disclosure, a “contrast ratio” is a ratio of brightness between a first and a second surface or color. Brightness may be determined under typical lighting conditions. Brightness may be a function of reflectance, transmittance, absorbance, and/or scatter in addition to lighting conditions. Brightness may be measured according to any known process, including without limitation digital photography. As used in this disclosure, a “minimum contrast threshold” is a contrast ratio below which insufficient contrast precludes a therapeutic optokinetic stimulus. In some cases, contrast ratio may be determined along a scale where maximum contrast ratio (black and white) is 21:1. In this case, a minimum contrast threshold may be 2:1, 4:1, 10:1, 15:1, or the like. In some cases, first color and second color may be arranged on surface area of optokinetic ball in a pattern. Pattern may include any pattern described in this disclosure, for example with reference to FIGS. 1-4. Pattern may be configured to produce an optokinetic stimulus when optokinetic ball is rotated. As used in this disclosure, an “optokinetic stimulus” is a visual phenomenon that is capable of inducing an optokinetic response.

With continued reference to FIG. 5, in some cases, step 505 may include performing oculomotor training as a function of a training parameter. As used in this disclosure, a “training parameter” is any variable associated with oculomotor training, for example a variable that may be controlled or varied throughout training.

Still referring to FIG. 5, in some embodiments of method 500, at least a training parameter may include at least a static body position parameter. As used in this disclosure, a “static body position parameter” is apposition or manner of arrangement for a participant. Exemplary static body position parameters include, without limitation, seated position (for example, with back support, without back support, without back support on a non-compliant surface (such as foam, BOSU®, and the like), kneeling (for example, on level ground, on non-level ground, on a non-compliant surface, and the like), half kneeling (for example, on level ground, on non-level ground, on a non-compliant surface, and the like), standing (for example, on level ground, on non-level ground, on a non-compliant surface, and the like), and the like. In some cases, method 500 may further comprise selecting, using a computing device, at least a static body position as a function of at least an oculomotor measure. In some cases, method 500 may additionally include positioning participant according to at least a static body position.

Still referring to FIG. 5, in some embodiments of method 500, at least a training parameter may include at least a dynamic balance task. As used in this disclosure, a “dynamic balance task” is any performance in which a participant moves and must maintain balance. Exemplary non-limiting dynamic balance tasks include walking, jogging, ladder drills, step ups, running, jumping, jump turns, sport specific tasks/activities, and the like. In some cases, method 500 may additionally include selecting, using a computing device, at least a dynamic balance task as a function of oculomotor response. In some cases, method 500 may additionally include performing, using participant, at least a dynamic balance task.

Still referring to FIG. 5, in some embodiments of method 500, at least a training parameter may include at least a cognitive task. As used in this disclosure, a “cognitive task” is any performance in which a participant is asked to think about subjects unrelated to her present physiological performance. Exemplary non-limiting cognitive tasks include doing math (for example, adding/subtracting by sevens), listing (for example, U.S. states, U.S. presidents, vegetables, and the like), simple recall tasks, and the like. In some cases, method 500 may additionally include selecting, using a computing device, at least a cognitive task as a function of oculomotor measure. In some cases, method 500 may additionally include performing, using participant, at least a cognitive task.

Still referring to FIG. 5, in some embodiments of method 500, at least a training parameter may include at least a propulsion location. As used in this location, a “propulsion location” is a position, often determined relative a participant, from which an optokinetic ball may be propelled. In some cases, propulsion location may be selected in order to help target different aspects of smooth pursuits, VOR x1, convergence training, VOR cancellation, and the like. In some cases, method 500 may additionally include selecting, using a computing device, at least a propulsion location as a function of oculomotor measure. In some cases, method 500 may additionally include propelling optokinetic ball substantially from at least a propulsion location.

Still referring to FIG. 5, in some embodiments, method 500 may additionally include selecting, using a computing device, at least a training parameter as a function of at least an oculomotor measure. In some cases, selection of one or more of training parameter and propulsion parameter may include any computerized selection method described in this disclosure, including without limitation machine learning processes, look up tables (LUTs), decision trees, and the like.

Still referring to FIG. 5, in some cases, selecting at least a training parameter may include use of one or more machine learning processes. Machine-learning processes have been described earlier in this disclosure. For example, selecting a training parameter may include inputting a training parameter training data into a training parameter machine learning process, training a training parameter machine learning model as a function of the training parameter machine learning process, inputting the at least an oculomotor measure into the training parameter machine learning model, and selecting the at least a training parameter as function of the training parameter machine learning model. As used in this disclosure, “training parameter training data” is a training data set that includes oculomotor measures correlated to training parameters. As used in this disclosure, a “training parameter machine learning process” is any machine learning process that is configured to, ultimately, output a training parameter. As used in this disclosure, a “train parameter machine learning model” is any machine learning model that is configured to output a training parameter as a function of an inputted oculomotor measure.

With continued reference to FIG. 5, at step 510, method 500 may include propelling the optokinetic ball to a participant according to at least a propulsion parameter. As used in this disclosure a “propulsion parameter” is any variable associated with propelling an optokinetic ball, for example a variable that may be controlled or varied throughout training. In some embodiments of method 500, at least a propulsion parameter may include one or more of direction, velocity, and rotational velocity. In some embodiments of method 500, propelling optokinetic ball further comprises one or more of tossing, bouncing, kicking, or hitting ball with object (bat, hockey stick, and the like).

With continued reference to FIG. 5, at step 515, method 500 may include varying at least a propulsion parameter. Varying propulsion parameter may include varying rotational speed of optokinetic ball, velocity of ball, arc of travel of the ball, and the like.

Still referring to FIG. 5, in some embodiments, method 500 may additionally include detecting, using an oculomotor device, at least an oculomotor measure as a function of an oculomotor response of the participant. As used in this disclosure, an “oculomotor device” is any device or system that may be used, with or without a trained operator, to measure a participant's oculomotor function. Oculomotor device may include an optokinetic strip, an optokinetic drum, a video, an augmented reality or virtual reality display and content. In some cases, an oculomotor device may include an eye tracking system. In some cases, an eye tracking system may include one or more digital cameras. In some cases, eye tracking may include near infrared illumination configured to illuminate an eye thereby forming bright/dark spots. In some cases, bright and/or dark spot imaging may be used to determine eye position (i.e., gaze) and/or movement. In some cases, an oculomotor device may be used to detect at least an oculomotor measure as a function of a participant's oculomotor response. As used in this disclosure, an “oculomotor measure” is at least an element of information that characterizers, describes, or otherwise indicates a participants oculomotor function or oculomotor response. In some cases, an oculomotor measure may be detected by an eye sensor.

Still referring to FIG. 5, in some embodiments, oculomotor device may include at least an eye sensor. As used in this disclosure, an “eye sensor” is any system or device that is configured or adapted to detect an eye parameter as a function of an eye phenomenon. In some cases, at least an eye sensor may be configured to detect at least an eye parameter as a function of at least an eye phenomenon. As used in this disclosure, an “eye parameter” is an element of information associated with an eye. Exemplary non-limiting eye parameters may include blink rate, eye-tracking parameters, pupil location, gaze directions, pupil dilation, and the like. Exemplary eye parameters are described in greater detail below. In some cases, an eye parameter may be transmitted or represented by an eye signal. An eye signal may include any signal described in this disclosure. As used in this disclosure, an “eye phenomenon” may include any observable phenomenon associated with an eye, including without limitation focusing, blinking, eye-movement, and the like. In some embodiments, at least an eye sensor may include an electromyography sensor. Electromyography sensor may be configured to detect at least an eye parameter as a function of at least an eye phenomenon.

Still referring to FIG. 5, in some embodiments, eye sensor may include an optical eye sensor. Optical eye sensor may be configured to detect at least an eye parameter as a function of at least an eye phenomenon. In some cases, an optical eye sensor may include a camera directed toward one or both of person's eyes. In some cases, optical eye sensor may include a light source, likewise directed to person's eyes. Light source may have a non-visible wavelength, for instance infrared or near-infrared. In some cases, a wavelength may be selected which reflects at an eye's pupil (e.g., infrared). Light that selectively reflects at an eye's pupil may be detected, for instance by camera. Images of eyes may be captured by camera. As used in this disclosure, a “camera” is a device that is configured to sense electromagnetic radiation, such as without limitation visible light, and generate an image representing the electromagnetic radiation. In some cases, a camera may include one or more optics. Exemplary non-limiting optics include spherical lenses, aspherical lenses, reflectors, polarizers, filters, windows, aperture stops, and the like. In some cases, at least a camera may include an image sensor. Exemplary non-limiting image sensors include digital image sensors, such as without limitation charge-coupled device (CCD) sensors and complimentary metal-oxide-semiconductor (CMOS) sensors, chemical image sensors, and analog image sensors, such as without limitation film. In some cases, a camera may be sensitive within a non-visible range of electromagnetic radiation, such as without limitation infrared. As used in this disclosure, “image data” is information representing at least a physical scene, space, and/or object (e.g., person or person's eyes). In some cases, image data may be generated by a camera. “Image data” may be used interchangeably through this disclosure with “image,” where image is used as a noun. An image may be optical, such as without limitation where at least an optic is used to generate an image of an object. An image may be material, such as without limitation when film is used to capture an image. An image may be digital, such as without limitation when represented as a bitmap. Alternatively, an image may be comprised of any media capable of representing a physical scene, space, and/or object. Alternatively where “image” is used as a verb, in this disclosure, it refers to generation and/or formation of an image.

Still referring to FIG. 5, an exemplary camera is an OpenMV Cam H7 from OpenMV, LLC of Atlanta, Ga., U.S.A. OpenMV Cam includes a small, low power, microcontroller which allows execution of processes. OpenMV Cam comprises an ARM Cortex M7 processor and a 640×480 image sensor operating at a frame rate up to 150 fps. OpenMV Cam may be programmed with Python using a Remote Python/Procedure Call (RPC) library. OpenMV CAM may be used to operate image classification and segmentation models, such as without limitation by way of TensorFlow Lite; detect motion, for example by way of frame differencing algorithms; detect markers, for example blob detection; detect objects, for example face detection; track eyes; detection persons, for example by way of a trained machine learning model; detect camera motion, for example by way of optical flow detection; detect and decode barcodes; capture images; and record video.

Still referring to FIG. 5, in some cases, a camera may be used to determine eye patterns (e.g., track eye movements). For instance, camera may capture images and processor (internal or external) to camera may process images to track eye movements. In some embodiments, a video-based eye tracker may use corneal reflection (e.g., first Purkinje image) and a center of pupil as features to track over time. A more sensitive type of eye-tracker, a dual-Purkinje eye tracker, may use reflections from a front of cornea (i.e., first Purkinje image) and back of lens (i.e., fourth Purkinje image) as features to track. A still more sensitive method of tracking may include use of image features from inside eye, such as retinal blood vessels, and follow these features as the eye rotates. In some cases, optical methods, particularly those based on video recording, may be used for gaze-tracking and may be non-invasive and inexpensive.

For instance, in some cases a relative position between camera and participant may be known or estimable. Pupil location may be determined through analysis of images (either visible or infrared images). In some cases, camera may focus on one or both eyes and record eye movement as viewer looks. In some cases, eye-tracker may use center of pupil and infrared/near-infrared non-collimated light to create corneal reflections (CR). A vector between pupil center and corneal reflections can be used to compute a point of regard on surface (i.e., a gaze direction). In some cases, a simple calibration procedure with an individual person may be needed before using an optical eye tracker. In some cases, two general types of infrared/near-infrared (also known as active light) eye-tracking techniques can be used: bright-pupil (light reflected by pupil) and dark-pupil (light not reflected by pupil). Difference between bright-pupil and dark pupil images may be based on a location of illumination source with respect to optics. For instance, if illumination is coaxial with optical path, then eye may act as a retroreflector as the light reflects off retina creating a bright pupil effect similar to red eye. If illumination source is offset from optical path, then pupil may appear dark because reflection from retina is directed away from camera. In some cases, bright-pupil tracking creates greater iris/pupil contrast, allowing more robust eye-tracking with all iris pigmentation, and greatly reduces interference caused by eyelashes and other obscuring features. In some cases, bright-pupil tracking may also allow tracking in lighting conditions ranging from total darkness to very bright.

Still referring to FIG. 5, alternatively, in some cases, a passive light optical eye tracking method may be employed. Passive light optical eye tracking may use visible light to illuminate. In some cases, passive light optical tracking yields less contrast of pupil than with active light methods; therefore, in some cases, a center of iris may be used for calculating a gaze vector. In some cases, a center of iris determination requires detection of a boundary of iris and sclera (e.g., limbus tracking). In some case, eyelid obstruction of iris and our sclera may challenge calculations of an iris center.

Still referring to FIG. 5, some optical eye tracking systems may be head-mounted, some may require the head to be stable, and some may function remotely and automatically track the head during motion. Optical eye tracking systems may capture images at frame rate. Exemplary frame rates include 15, 30, 60, 120, 240, 350, 1000, and 1250 Hz.

Still referring to FIG. 5, in some embodiments, a goal of oculomotor training with optokinetic ball is to help desensitize patients to optokinetic stimulation. Participants that could benefit from training, in some cases, may include those with difficulty observing optokinetic stimulation, visually induced dizziness (VID), visual vertigo, persistent postural perceptual (3PD), among other conditions. In some cases, participants may be appropriately screened, for instance with an oculomotor device, prior to oculomotor training to determine that optokinetic stimulus is appropriate. With continued optokinetic training, proper stimulus attained during rehabilitation, the goal is to help the participant adapt and habituate to the stimulus. In some cases, oculomotor training may aid in allowing participant to be able to walk in busy environments, respond to visually sensory rich environments (driving, sporting environments, etc.), and be able to perform sensory integration tasks that appropriately challenge the vestibular, oculomotor, cardiorespiratory, and cognitive systems.

Still referring to FIG. 5, in some embodiments of method 500, participant will catch optokinetic ball. In some cases, catching a ball involves multiple human systems to work in concert. For instance, a participant catching an optokinetic ball must effectively track the ball with his/her eyes (smooth pursuits, convergence, VOR, optokinetic reflex). Based on the participant's visual input, participant must effectively determine spatial perception to reach for optokinetic ball. Participant must also have kinesthetic and proprioceptive awareness to complete the task and catch optokinetic ball. This task can be further complicated by varying any propulsion parameters and/or training parameter, for instance those described in detail above. Propulsion and/or training parameters may be added/varied independently or together. Exemplary propulsion and/or training parameters include without limitation dynamic balance tasks (e.g., walking, running, etc.), non-compliant surfaces (e.g., grass, sand, foam, balance systems (e.g., BOSU, Shuttle, etc.), dual cognitive tasks (e.g., counting backwards by 7's, naming items on a list [e.g., types of vegetables, presidents, U.S. states, street names, etc.], aerobic based tasks (e.g., step ups, ladder drills, running, etc.), activities that further challenge vestibulo-ocular system (e.g., over the shoulder ball catch and toss), activities that challenge reaction (e.g., jump turn catch and toss), among many others.

Still referring to FIG. 5, in some embodiments, optokinetic ball may be configured to help induce an optokinetic response within a participant to challenge the vestibular, oculomotor systems with added optokinetic stimulation while reacting to the ball (catching it, hitting it, kicking it, and the like). In some cases, some participants undergoing oculomotor training may exhibit increased symptoms of instability, nausea, dizziness, headache, among other symptoms. In some cases, (e.g., habituation training) exhibition of these symptoms may serve as an indication of effective training. In some cases, exhibition of these symptoms may serve as end-point indicating a stopping point of training. In some cases, oculomotor training may be performed as a part of one or more of habituation training, substitution training, adaptation training and the like.

Still referring to FIG. 5, in some embodiments, optokinetic ball may only be used with participants that exhibit an ability to withstand optokinetic stimulation. In some cases, oculomotor testing or screening may be performed, for instance with an oculomotor device such as without limitation videos, optokinetic strips, or optokinetic drum. In some cases, participants may also be tested or screened for balance and/or oculomotor control prior to or during oculomotor training.

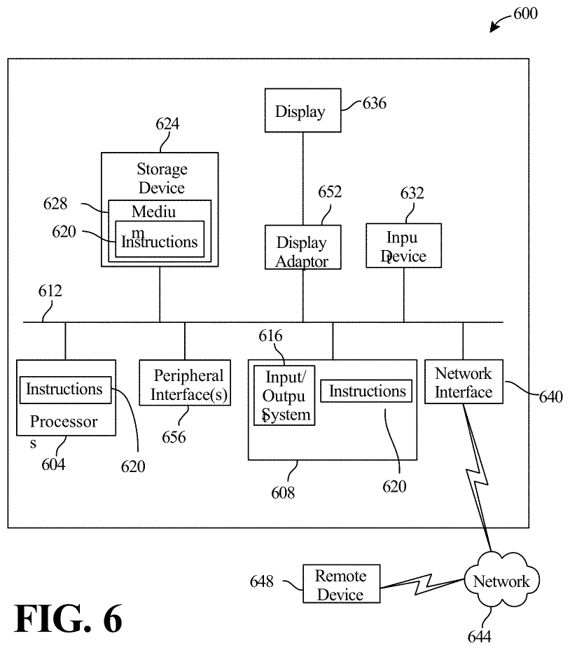

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Memory 608 may include various components (e.g., machine-readable media) including, but not limited to, a random-access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof.

Computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In one example, software 620 may reside, completely or partially, within machine-readable medium 628. In another example, software 620 may reside, completely or partially, within processor 604.

Computer system 600 may also include an input device 632. In one example, a user of computer system 600 may enter commands and/or other information into computer system 600 via input device 632. Examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system of patterned balls configured for use in therapies, the system comprising:
a first ball, wherein the first ball comprises:
a first color disposed on a portion of the surface of the first ball and a second color disposed on a portion of the surface of the first ball;
a first pattern comprising the first color and the second color disposed on the first ball associated with a first therapy;
a first axis of rotation about which the first ball may rotate;
a second ball, wherein the second ball comprises:
a third color disposed on a portion of the surface of the first ball and a fourth color disposed on a portion of the surface of the second ball;
a second pattern comprising the third color and the fourth color disposed on the second ball associated with a second therapy;
a second axis of rotation about which the second ball may rotate;
a suspension assembly, wherein the suspension assembly comprises:
a first suspension apparatus configured to suspend the first ball in a first orientation associated with the first therapy;
a second suspension apparatus configured to suspend the second ball in a second orientation associated with the second therapy; and
a rotation apparatus configured to rotate at least the first ball about the first axis of rotation and the second ball about the second axis of rotation.

2. The system of claim 1, further comprising a computing device, the computing device configured to:
receive a user input from a user associated with a first user condition;
correlate the first user condition to the first pattern; and
select the first ball that includes the first pattern correlated to the first user condition.

3. The system of claim 1, wherein the first suspension apparatus is mechanically coupled to the first ball at the first axis of rotation.

4. The system of claim 1, wherein the rotation apparatus is configured to rotate the first ball for a first amount of time.

5. The system of claim 1, wherein the first suspension apparatus includes a first wire with a first length associated with the first therapy.

6. The system of claim 1, wherein the first suspension apparatus is mechanically coupled to the rotation apparatus at a first end, and mechanically coupled to the first ball at a second end.

7. The system of claim 1, wherein the suspension assembly includes a framework in which the first ball and the second ball are disposed within.

8. The system of claim 1, wherein at least the first ball is disposed within a recess in the suspension assembly.

9. The system of claim 1, wherein the suspension assembly is configurable to have a second length associated with the second therapy.

10. The system of claim 1, wherein at least the first ball is disposed in a framework with at least a portion of the ball exposed.

11. A method of training comprising:
performing, using an optokinetic ball, oculomotor training as a function of at least a training parameter, wherein performing the oculomotor training comprises:
propelling the optokinetic ball to a participant according to at least a propulsion parameter; and
varying the at least a propulsion parameter;
wherein the optokinetic ball comprises:
a first color covering about half of a surface area of the optokinetic ball;
a second covering about half of the surface area of the optokinetic ball, wherein a contrast ratio between the first color and the second color is no less than a minimum contrast threshold; and
wherein, the first color and the second color are arranged on the surface area of the optokinetic ball in a pattern configured to produce an optokinetic stimulus when the optokinetic ball is rotated.

12. The method of claim 11, further comprising detecting, using an oculomotor device, at least an oculomotor measure as a function of an oculomotor response of the participant.

13. The method of claim 12, wherein the at least a training parameter includes at least a static body position parameter, and the method further comprises:
selecting, using a computing device, the at least a static body position as a function of the at least an oculomotor measure; and
wherein performing the oculomotor training further comprises positioning the participant according to the at least a static body position.

14. The method of claim 12, wherein the at least a training parameter includes at least a dynamic balance task, and the method further comprises:
selecting, using a computing device, the at least a dynamic balance task as a function of the oculomotor response; and
wherein performing the oculomotor training further comprises performing, using the participant, the at least a dynamic balance task.

15. The method of claim 12, wherein the at least a training parameter includes at least a cognitive task, and the method further comprises:
selecting, using a computing device, the at least a cognitive task as a function of the oculomotor measure; and
wherein performing the oculomotor training further comprises performing, using the participant, the at least a cognitive task.

16. The method of claim 12, wherein the at least a training parameter includes at least a propulsion location, relative the participant, and the method further comprises:
selecting, using a computing device, the at least a propulsion location as a function of the oculomotor measure; and
wherein performing the oculomotor training further comprises propelling the optokinetic ball substantially from the at least a propulsion location.

17. The method of claim 12, further comprising selecting, using a computing device, the at least a training parameter as a function of the at least an oculomotor measure.

18. The method of claim 17, wherein selecting the at least a training parameter includes:
inputting a training parameter training data into a training parameter machine learning process;
training a training parameter machine learning model as a function of the training parameter machine learning process;
inputting the at least an oculomotor measure into the training parameter machine learning model; and
selecting the at least a training parameter as function of the training parameter machine learning model.

19. The method of claim 11, wherein the at least a propulsion parameter includes one or more of direction, velocity, and rotational velocity.

20. The method of claim 11, wherein propelling the optokinetic ball further comprises one or more of tossing, bouncing, and kicking.
